(19) United States
(12) Patent Application Publication
(10) Pub. No.: US 2003/0008777 A1
(43) Pub. Date: Jan. 9, 2003

(54) Phosphorus doped activated alumina

(76) Inventors: Conny W. Hansen, Odense (DK); Henning Hofius, Aachen (DE); Kai L. Nielsen, Odense (DK)

Correspondence Address: MANELLI DENISON & SELTER, 2000 M STREET NW SUITE 700, WASHINGTON, DC, 20036-3307, US

(21) Appl. No.: 10/101,060

(22) Filed: Mar. 20, 2002

Related U.S. Application Data
(63) Continuation-in-part of application No. PCT/EP00/09347, filed on Sep. 25, 2000.
(60) Provisional application No. 60/279,419, filed on Mar. 29, 2001.

(30) Foreign Application Priority Data
Sep. 24, 1999 (DE) 99118849.1

(51) Int. Cl. A01N 57/00

(52) U.S. Cl. 504/194

(57) ABSTRACT

Provided is a process for producing granules of a phosphorus doped activated alumina from aluminum hydroxide and a phosphorus source. The granules can be used as growth regulator, especially as low phosphorus buffer in potted plants.

This is a Continuation-in-Part of International Application PCT/EPO0/09347, filed on Sep. 25, 2000, which claims priority to German Patent Application No. 99118849.1 filed on Sep. 24, 1999, the complete disclosures of which are incorporated herein by reference. This application also claims priority to U.S. Ser. No. 60/279,419, filed on Mar. 29, 2001, the complete disclosure of which is incorporated herein by reference.

1. Field of the Invention

The invention relates to a new process for producing granules of phosphorus doped activated alumina, the granules themselves, and the use of the granules as a growth regulator, especially as a low phosphorus buffer in potted plants. The term “phosphorus” is used herein to mean pentavalent inorganic phosphorus (Pv), such as phosphate.

2. Background of the Invention

Chemical growth regulation is widely used in conventional horticultural production systems to produce flowering potted plants having a desired height and shape. Most of the species produced as potted plants require growth regulation in order to become a saleable product. However, restrictions against the use of chemical growth regulators due to environmental concerns has caused pressure to find alternative environment-friendly ways of plant growth regulation.

A method of fertilising plants with phosphorus charged on alumina in which the phosphorus is slowly desorbed and made available for plant uptake is disclosed in US-A 5 693 119. The phosphorus source is an acid treated activated alumina, which is obtained by contacting an active alumina with an aqueous solution of potassium dihydrogenphosphate for three days and then two days of drying at a relatively low temperature. This process is too labourious for large scale production and it has been found that the drying leads to some loss of activity. Furthermore, the (hydrochloric) acid treatment results in a considerable chloride content of the resulting P buffer, which is undesirable since many plant species are chloride-sensitive.

In order to successfully use phosphorus buffers for sufficient growth regulation, a strict control of phosphorus desorption is extremely important. Plants need to be grown under moderate and controlled phosphorus deficiency for sufficient growth regulation, and any loss of buffer activity may result in undesirably low phosphorus concentration in the growth media and may cause deleterious phosphorus starvation.

Phosphorus doped alumina produced according to US-A 5 693 119 does not desorb the phosphorus in a precisely controllable manner that would be necessary for controlled phosphorus deficiency and optimal growth regulation. It has also been found that this doped alumina contains a large amount of moisture (as determined at 300° C.), usually more than 10%.

There is thus a need for a commercially feasible plant growth regulator that is environment-friendly.

### SUMMARY OF THE INVENTION

One object of the invention is to produce a phosphorus doped activated alumina, which does not incur the drawbacks known in the art. A further object of the invention is to provide an improved and environment-friendly growth regulator, especially a low P-buffer for potted plants.

It has been found that phosphorus doped activated alumina produced according to the present invention surprisingly exhibited excellent properties as growth regulator, especially as a low P-buffer in potted plants, that is commercially feasible and environment-friendly.

The invention provides a method of making a phosphorus doped activated alumina comprising the steps of:

1. compacting a mixture comprising a phosphorus source and at least one of an aluminium hydroxide or an aluminum hydroxide containing material;

2. size reducing the compacted material; and

3. activating the size reduced material at a temperature of at least 300° C., preferably 350° C. to 600° C., to form granules and, optionally,

4. classifying the granules.

### BRIEF DESCRIPTION OF THE DRAWINGS

FIG. 1 shows the phosphorus desorption of the six samples (1.2.1 to 1.2.6) of phosphorus doped activated alumina obtained in example 1.2.

FIG. 2 shows the influence of the phosphorus desorption of the six samples of phosphorus doped activated alumina on plant height.

FIG. 3 shows the influence of the phosphorus desorption of the six samples of phosphorus doped activated alumina on plant fresh weight (hollows bars: leaves, solid bars: stem).

FIG. 4 shows the influence of the phosphorus desorption of the six samples of phosphorus doped activated alumina on plant dry weight (hollows bars: leaves, solid bars: stem).

FIG. 5 shows the pH buffering behaviour of two different products according to the invention (“Low-P buffer” and “High-P buffer”) during the production of Argeranthemum frutescens on peat based growing media.

FIG. 6 shows the pH dependency of the potassium desorption from phosphorus doped activated alumina according to the invention.

FIG. 7 shows the influence of the phosphorus doped activated alumina according to the invention on the growth rate of tomato (Lycopersicon esculentum Mill.) grown on different peat qualities.

FIG. 8 shows the root area (measured on the bottom of the pot) of tomato grown under the same conditions as described above for FIG. 7.

FIG. 9 shows the germination rate of tomato measured 10 days after sowing. The other conditions were the same as described above for FIG. 7.

### DETAILED DESCRIPTION OF THE INVENTION

The term “aluminium hydroxide” as used herein comprises the use of Al(OH)₃ and/or AlOOH. Preferred Aluminium hydroxides for use as starting materials include those commercially available that have been produced by the well-known Bayer process, such as aluminium hydroxides of the MARTINAL® type of Alusuisse Martinswerk, Bergheim, Germany. Though not preferred, a pseudoboehmite having the formula AlOOH or mixtures thereof with aluminium hydroxide may also be used as starting material. Even aluminium hydroxide containing materials, such as bauxites, natural raw materials containing naturally occurring phases of aluminium hydroxide, for example gibbsite, boehmite, and/or diaspore, can be used as a starting material. In general, the higher the aluminium hydroxide content and purity, the better the suitability as a P-buffer by achieving more controlled and specific reaction sites and/or higher P adsorption and desorption capacities by the formation of a higher specific surface area during activation.

When Bayer aluminium hydroxide is used, the particle diameter is preferably such that 95 wt. % of the particle size does not exceed 200 μm in grain diameter. The d₅₀ value preferably ranges between 30 μm and 150 μm.

The specific surface area (according to BET) of the starting material is not critical, but is usually 5 m²/g or less. The Na₂Oₜₒₜₐₗ content is preferably selected to be lower than 0.5 wt. % referring to Al₂O₃. In order to guarantee a satisfactory compaction process the moisture content is, depending on the grain size, preferably held below 2.0%.

The phosphorus source is preferably selected from phosphoric acid, salts derived from phosphoric acid or mixtures thereof. Alternatively, mineral phosphates, such as naturally occurring phosphates, or salts derived from mineral phosphates, such as calcium phosphates or ammonium phosphates, can be used.

Suitable salts derived from phosphoric acid can, for example, be selected from phosphates, monohydrogenphosphates or dihydrogenphosphates of potassium, magnesium and/or calcium, which may be supplemented by micronutrients such as zinc, iron and copper. Preferably, mixtures of phosphoric acid and a phosphate, monohydrogenphosphate or dihydrogenphosphate of potassium, magnesium and/or calcium and, optionally, zinc, iron or copper are utilized.

Phosphoric acid can function as a preferable pH adjustment source. However, if desired, pH adjustment can also be achieved using other mineral acids, such as hydrochloric acid or sulfuric acid, although not preferred because of the decomposition and formation of toxic gases during the activation treatment or the resulting chloride content.

The cations mentioned also play an important role as nutrient elements. They can be provided in the form of the respective phosphate salt, or if desired, additionally in the form of other common salts, such as sulfates or nitrates.

In the mixture containing phosphoric acid and salt(s) derived from phosphoric acid, the ratio of phosphoric acid to salt(s) derived from phosphoric acid is preferably in the range of 1:0.3 to 1:20. However, a loading with 100% phosphoric acid or 100% salt derived from phosphoric acid is possible.

Particularly good results have been obtained with mixtures of phosphoric acid and potassium dihydrogenphosphate, the mixtures preferably having a phosphoric acid content of 5 wt. % to 15 wt. % and a potassium dihydrogenphosphate content of 85 wt. % to 95 wt. %, calculated from the mixture to be compacted.

In order to facilitate mixing, the phosphorus source preferably is a material having a grain diameter in the 50% range (d₅₀) of 1 μm to 100 μm.

The content of the phosphorus source (calculated as PO₄³⁻) in the mixture to be compacted is preferably in the range of 1 wt. % to 20 wt. %, and more preferably 5 wt. % to 16 wt. %.

Prior to compaction the mixture of aluminium hydroxide and the phosphorus source can be homogenised in a suitable blending equipment. Such equipment is known to those skilled in the art. Common equipment which can be operated either continuously or discontinuously is available from several manufacturers, for example, Bepex Hosokawa (Nauta blender), from Lödige or from Eirich.

Compaction can be carried out with equipment and according to methods known by those skilled in the art. Suitable compaction of aluminium hydroxide is for instance exemplified in DE-C-25 14 758, which is incorporated herein by reference. Usually the blended and homogenised material is fed in a screw conveyor unit, which has the task of constantly feeding the pre-compressed material in the compactor.

A preferred compactor unit is characterised by two counterrotating rollers, one fixed and one movable, forming a narrow gap (nip) of variable width, for example, of 2 cm or less. The movable roller should be able to expose the feedstock between the rollers to a compacting force of 50 kN to 200 kN per cm of nip length.

The result of the compaction treatment is usually a plate or a ribbon with a thickness of, for example, 0.4 cm to 0.6 cm.

Size reduction usually comprises a series of steps. The compacted material can be first coarsely crushed in a suitable crushing unit. A further size reduction can then, for example, be achieved using a hammer crusher thereby, depending on the outlet screen, to produce a desired grain diameter, such as about 4 mm. Pre-classification and screening can then be accomplished, for example, using a screening sizer unit, thereby finally obtaining a granule-like material. In a preferred embodiment, after this size reduction steps, at least 95 wt. % of the particles have a particle size of between 0.1 mm and 1.5 mm, the most preferred diameter being from 0.5 mm to 1.5 mm.

The apparent density (as determined with a Hg-porosimeter at low pressure) of the granules obtained ranges in general between 2.2 and 2.4 g/cm³.

Suitable means for carrying out size reduction and classification are well known to those skilled in the art and can be used herein.

The activation of the compacted granules takes place in a suitable kiln or oven. Good results have been achieved using an indirectly fired rotary kiln, without lining, wherein the granules are treated at an activation temperature of from 350° C. to 800° C., preferably 350° C. to 600° C. The preferred temperature at the shell of the kiln has been determined to be between 650° C. and 750° C. The activation step should be carried out for a time sufficient to raise the temperature of the granules to the desired activation temperature. In general, the larger the kiln or oven, the longer the time required to have the temperature of the granules reach the desired activation temperature. The activation step can be conducted continuously or in batches as desired. A preferred time range is from 20 minutes to 90 minutes.

If desired, the activated phosphorus doped alumina granules can be further processed with respect to granule size distribution.

Preferably, 90 wt. % of the activated phosphorus doped alumina granules have a grain diameter smaller than 1.25 mm. The average particle size in the 50% range (d₅₀) of the activated material is preferably in the range of 0.5 mm to 1.0 mm. The bulk density of the activated material is preferably between 650 g/l and 950 g/l, whereas the pycnometric density is preferably about 3.1 to 3.2 g/cm³.

The quality of the activation can be controlled over the specific surface area (measured according to BET) and the loss on ignition (LOI) of the activated material. The surface area of the activated material should be in the range of 120 m²/g to 380 m²/g, preferably in the range of 250 m²/g to 320 m²/g. The loss on ignition of the activated material preferably lies between 1% and 15%, most preferably 4% to 10%.

The activated phosphorus doped alumina granules produced according to the present process preferably have a phosphorus content between 50 g PO₄³⁻/kg and 150 g PO₄³⁻/kg, or 5 to 15 wt. %.

The granular phosphorus doped aluminas produced according to the invention are capable of providing aqueous solutions, for example, the aqueous phase in the growth media of horticultural plants, with phosphorus in a wide concentration range as desired and are, thus, well-suited as growth regulators.

Depending on the phosphorus source used, the growth media can further be provided with the respective cation of the phosphorus source, for example, with potassium, magnesium and/or calcium as well as zinc, iron or copper, which are elements that also play an important role as nutrient or micronutrient elements.

The desorption of phosphorus and optional other nutrient elements from the activated alumina depends on the concentration of phosphorus and the other nutrient elements in the activated phosphorus doped alumina granules as well as on the pH of the buffer solution. It has been found that the phosphorus doped alumina granules according to the invention exhibit buffering properties in that they do not only supply phosphorus to the media via desorption, but may also absorb excess phosphorus from the media.

It has been found that, depending on the buffer system employed, a predictable desorption of phosphorus, resulting in a phosphorus concentration in the liquid phase in the range of about 5 to 5000 μM, can be achieved. Especially when used as low-P buffer in potted plants, low and controlled phosphorus concentrations, usually in the range of 5 to 100 μM, preferably 10 to 50 μM, can surprisingly be provided throughout the whole production period of the respective potted plant. These low phosphorus concentrations, which are at least about twenty times lower than standard concentrations in nutrient solutions, showed strong growth retarding effect without reducing plant quality.

The granular phosphorus doped activated aluminas according to the invention can also be characterised by a phosphorus content (calculated as PO₄³⁻) of 1 to 20 wt. %, a specific surface area (according to BET) of 120 to 380 m²/g, a moisture content (determined at 300° C.) of less than 5%, preferably less than 1.5%, and a loss on ignition (determined at 1200° C.) of 1% to 15%, preferably 4% to 10%. Preferably, they have an average particle size in the 50% range (d₅₀) of 0.5 mm to 1.0 mm.

The activated phosphorus doped alumina granules of the present invention show a great potential to reduce or even replace chemical growth regulation in several species of plants. The method has been found to be suitable for large-scale produced crops or flowering potted plants such as asters (Aster novi-belgii), marguerite daisies (Argeranthemum frutescens), Poinsettia (Poinsettias pulcherrima), miniature roses (Rosa-hybrid), Persian violet (Exacum affine) and chrysanthemum (Dendranthema grandiflorum-hybrid) having considerable need for growth regulation. The species represent a large diversity, both with regard to the type of chemical growth regulators traditionally used by the industry and the number of applications (amount) required for sufficient growth regulation. All species have shown a strong and similar response to low phosphorus availability.

Besides the growth regulating properties based on their phosphorus buffer activity, the activated phosphorus doped alumina granules of the present invention show several further advantageous features.

It has been found that they also exhibit pH buffering properties and may therefore be used as pH buffers in the growing media of plants, preferably potted plants. This is of particular importance for growing media based on materials having little buffer capacity.

Furthermore, it has been found that the present granules are also capable of desorbing nutrients other than phosphorus, for example potassium, in a predictable and controllable manner and may therefore act as potassium buffers. This is particularly surprising since phosphorus doped alumina prepared according to prior art methods (US-A-5 693 119) was found to show only very poor potassium desorption.

Another surprising feature of the present granules is their ability to improve peat-based growing media, which—depending on the origin and quality of the peat—often exhibit growth—and/or germination-inhibiting properties due to a content of certain soluble organic compounds. It has been found that the germination- and/or growth rates of several plant species on peat of poor quality can be increased considerably by addition of activated phosphorus doped alumina according to the present invention. Good results have been obtained with e. g. buckwheat (Fagopyrum esculentum Moench.), cress (Lepidium sativum L.), Chinese cabbage (Brassica rapa L. ssp. pekinensis Lour.), lettuce (Lactuca sativa L. and tomato (Lycopersicon esculentum Mill.). This product may therefore be used as an ameliorating agent for peat-based growing media for plants.

Still another advantageous property of the activated phosphorus doped alumina according to the present invention is its ability to supply several micronutrients, for example, Mn, Fe, Cu, Zn, and Mo, and control their concentration in the growing media of plants, preferably potted plants, by desorption or absorption. It has, for example, been found that it is able to reduce the iron content below the toxic concentrations sometimes encountered in the culture of iron-sensitive species such as Pentas lanceolata by absorbing iron from the growing media.

The following non-limiting examples illustrate several embodiments of the invention. The physical and chemical characteristics of the product were measured according to standard methods, for example ISO 803 (moisture content, determined at 300° C.) and ISO 806 (loss on ignition, determined at 1200° C.).

### EXAMPLES

1. Production of a Phosphorus Doped Alumina

1.2 Discontinuous Production of a Medium-P Buffer

Dry aluminium trihydroxide (Al(OH)₃, 1500 kg) with the following specification:

Moisture: 0.45 wt. %

Na₂O content: 0.29 wt. % (referred to Al₂O₃)

Loss on ignition (LOI): 34.9 wt. %

Bulk density: 1120 g/l

Grain size distribution:

>150 μm: 16.8 wt. %

>106 μm: 55.6 wt. %

>75 μm: 75.6 wt. %

<45 μm: 12.4 wt. %

was discontinuously blended and homogenised for 30 min with 25.7 kg of orthophosphoric acid (85 wt. %, technical quality) and 135 kg of monopotassium dihydrogenphosphate (KH₂PO₄, technical quality, average grain size d₅₀=50 μm) using a Nauta blender. This material was stored in a silo before using. Then a constant feed of 1200 kg/h was pre-densified in a screw conveyor unit and subsequently compacted between two rotating rollers forming a nip (gap) having a length of 15 cm. The roller diameter was 52 cm. The rollers were pressed together by hydraulic means, the measured (hydraulic) pressure being 200 bar corresponding to a compacting force of ca. 108 kN/cm in the nip. The resulting compacted ribbon/plate had a thickness (corresponding to the nip width) ranging between 4 and 6 mm. In the next step, the compacted aluminium trihydroxide plate was crushed using a single-roll crusher (“fissator”). Granules finer than 1 mm were separated from the process by screening. Further intense crushing was realised in a hammer crusher with an outlet screen size of 4 mm. Pre-classification and screening was carried out by a screening sizer (undersize: <0.71 mm; oversize: >1.12 mm). The “go”fraction was stored in a silo. A constant product feed (1100 kg/h) was activated in an indirectly fired rotary kiln (unlined steel shell, total length ca. 9 m, length of heated zone 7.2 m, diameter 90 cm, inclination 1°) rotating at approx. 2 rpm, wherein the granules were treated at a shell temperature of 750° C. for about 1 h. After activation the product was screened to obtain a fraction having 0.315 to 1.25 mm particle size.

The final product had the following characteristics:

Specific surface area (BET): 265 m²/g

Loss on ignition: 5.4 wt. %

Na₂Oₜₒₜₐₗ: 0.21 wt. % (referred to Al₂O₃)

Moisture (at 300° C.): 0.65 wt. %

Bulk density: 765 g/l

Pycnometric density: 3.14 g/cm³

Grain size distribution:

>1.00 mm: 8.0 wt. %

>0.50 mm: 82.7 wt. %

>0.315 mm: 98.7 wt. %

PO₄³⁻ content: 9.6 wt. %

K₂O content: 3.9 wt. %

1.2 Continuous production of low to medium phosphorus buffers

1350 kg/h of a dried aluminium trihydroxide (Al(OH)₃), with the following specification:

moisture: 0.2 wt. %

Na₂O content: 0.33 wt. % (referred to Al₂O₃)

Loss on ignition (LOI): 34.7 wt. %

Bulk density: 1200 g/l

Grain size distribution:

>200 μm: 1.6 wt. %

>150 μm: 11.9 wt. %

>75 μm: 82.4 wt. %

<45 μm: 3.1 wt. %

was continuously blended and homogenised with orthophosphoric acid (85 wt. %, technical quality) at a feed rate F1 and monopotassium dihydrogenphosphate (KH₂PO₄, technical quality, average grain size d₅₀=25 μm) at a feed rate F2 using a Nauta blender. This feed was pre-densified in a pre-compression screw conveyor unit. The power consumption of the screw conveyor was controlled in order to ensure a constant feed rate to the subsequently working roller-type compactor. Then the mixture was compacted between two counterrotating rollers forming a nip (cf. preceding example). The measured hydraulic pressure was 195 bar, corresponding to a compacting force of ca. 105 kN/cm. The resulting compacted ribbon/plate had a thickness ranging between 4 mm and 6 mm. In the next step, the compacted aluminium trihydroxide plate was crushed using a single-roll crusher (“fissator”). Granules finer than 1 mm were separated from the process by sieving. Further intense crushing was realised in a hammer crusher with an outlet screen size of 4 mm. Pre-classification and screening was carried out by a screening sizer (undersize: <0.71 mm; oversize: >1.25 mm). The “go”-fraction was stored in a silo. A constant product feed (1000 kg/h) was activated in an indirectly fired rotary kiln (details see above) wherein the granules were treated at a shell temperature of 730 ° C. After activation the product was screened to obtain a particle size between 0.315 mm and 1.25 mm. The final products had the following characteristics listed in Table 1:

TABLE 1

| Example No. | 1.2.1 | 1.2.2 | 1.2.3 | 1.2.4 | 1.2.5 | 1.2.6 |
|---|---|---|---|---|---|---|
| F1 [kg/h] | 11.5 | 11.5 | 11.5 | 11.5 | 11.5 | 11.5 |
| F2 [kg/h] | 3.0 | 12.7 | 49.7 | 66.2 | 118.5 | 250.7 |
| Surface area (BET) [m²/g] | 303 | 296 | 305 | 294 | 297 | 260 |
| Loss on ignition [wt. %] | 6.5 | 6.6 | 7.8 | 7.8 | 5.6 | 7.6 |
| Bulk density [g/l] | 815 | 825 | 805 | 725 | 680 | 685 |
| Granule size distribution | | | | | | |
| [wt. %] | | | | | | |
| >1.25 mm | 8.2 | 1.8 | 5.3 | 4.6 | 6.1 | 3.5 |
| >1.00 mm | 38.3 | 26.2 | 34.8 | 27.2 | 31.1 | 31.7 |
| >0.5 mm | 92.5 | 89.7 | 91.2 | 86.7 | 93.2 | 88.3 |
| >0.315 mm | 99.8 | 98.2 | 99.5 | 99.7 | 99.3 | 99.4 |
| PO₄³⁻ [wt. %] | 1.2 | 1.9 | 4.3 | 5.5 | 8.6 | 14.6 |
| K₂O [wt. %] | 0.11 | 0.45 | 1.7 | 2.3 | 3.8 | 7.0 |

2. Desorption and plant tests

Desorption of phosphorus from the six samples 1.2.1 to 1.2.6 was tested using Poinsettia as model plant. The following standard growing procedure for Poinsettia was followed except for phosphorus being provided with the phosphorus doped activated alumina.

Propagation:

Cuttings were propagated in peat at high phosphorus concentration (approx. 500 μM P) at a conventional greenhouse operation. After propagation the roots were rinsed free of the peat they were propagated in and transplanted into a P-free peat mixed with 2 wt. % phosphorus doped activated alumina.

Treatments:

Growth media was mixed with 2 wt. % of a sample of the phosphorus doped activated alumina of examples 1.2.1 to 1.2.6. Soil solution samples were taken after each irrigation and the samples were analysed for plant available phosphorus once weekly. The treatments started mid October and the plants were grown vegetatively until early January of the following year when they were harvested.

Replicates and statistics:

The experiment was designed as a randomised block design with two replicates per treatment.

Temperature:

20 ° C. day/night until 4 weeks after the treatment started, hereafter 18° C. during the rest of the production period.

Supplemental lighting:

Poinsettia requires short days (10-h day, 14-h night) for floral induction. The experiment was conducted during late fall and winter with natural short days. 20 hours of supplemental lighting was employed (60 μmol photons m⁻² s⁻¹) in order to keep the plants vegetative and to characterise maximum growth potential of the non-chemical growth regulated plants.

Irrigation:

Plants were irrigated once or twice every week with a solution providing: NH₄: 1 mM; NO₃: 11.3 mM; K: 4.6 mM; Ca: 3.5 mM; Mg: 0.7 mM; Fe: 39.4 mM; Mn: 17.9 mM; B: 6.4 mM; Cu: 13.9 mM; Zn: 3.8 mM; Mo: 0.8 mM; Na: 0.2 mM; SO₄: 0.7 mM. pH: 5.8-6.0 CO₂: 700 ppm

Growth regulation:

No chemical growth regulation was employed.

Data collection:

Ten weeks after transplanting 16 plants per treatment were harvested and the following was recorded:

Plant height:

Plant height was measured from the edge of the container to the apical meristem.

Fresh weight:

The fresh weight of leaves and stems was measured immediately after the shoot was excised from the root.

Dry weight:

The dry weight of leaves and stems was measured after 24 h of drying at 70° C.

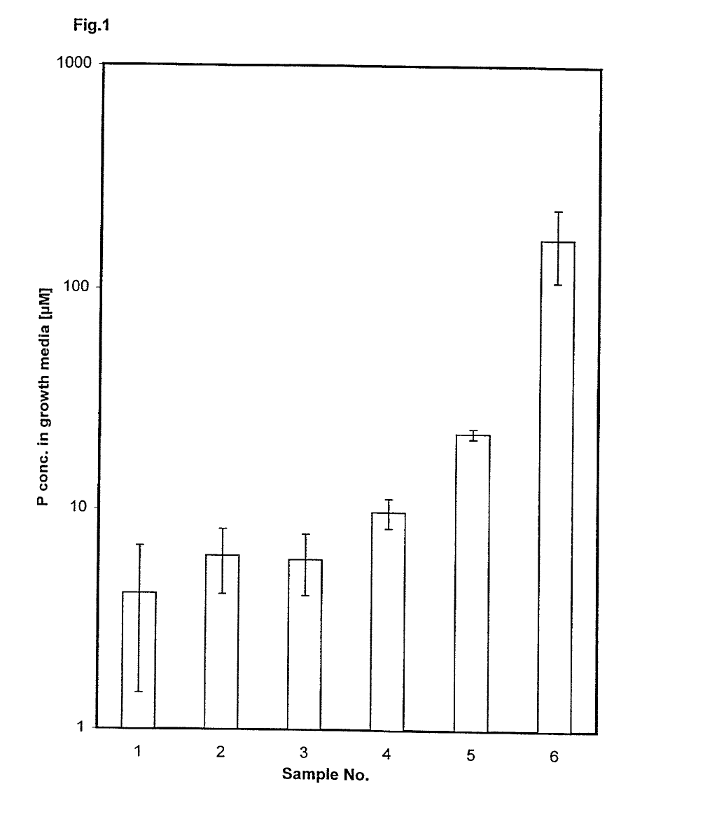

FIG. 1 shows the phosphorus desorption of the six samples (1.2.1 to 1.2.6) of phosphorus doped activated alumina obtained in example 1.2. Phosphorus desorption from several of the samples was low and stable, especially two of the samples (no. 4 and 5) showed low phosphorus desorption within the range required for an efficient growth regulation. The time dependency of phosphorus desorption was small in the samples where phosphorus desorption was low (nos. 1-5, see error bars) compared with that of sample no. 6 desorbing relatively high phosphorus concentrations.

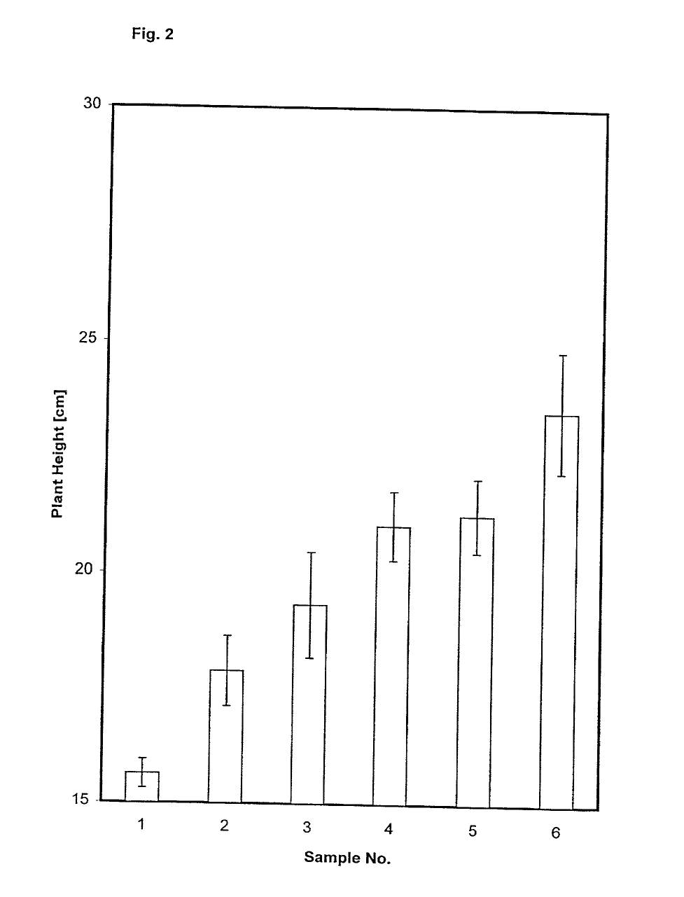

FIG. 2 shows the influence of the phosphorus desorption of the same six samples of phosphorus doped activated alumina on plant height. An efficient growth retardant effect was determined when plants were grown with low phosphorus concentration provided from phosphorus doped activated alumina.

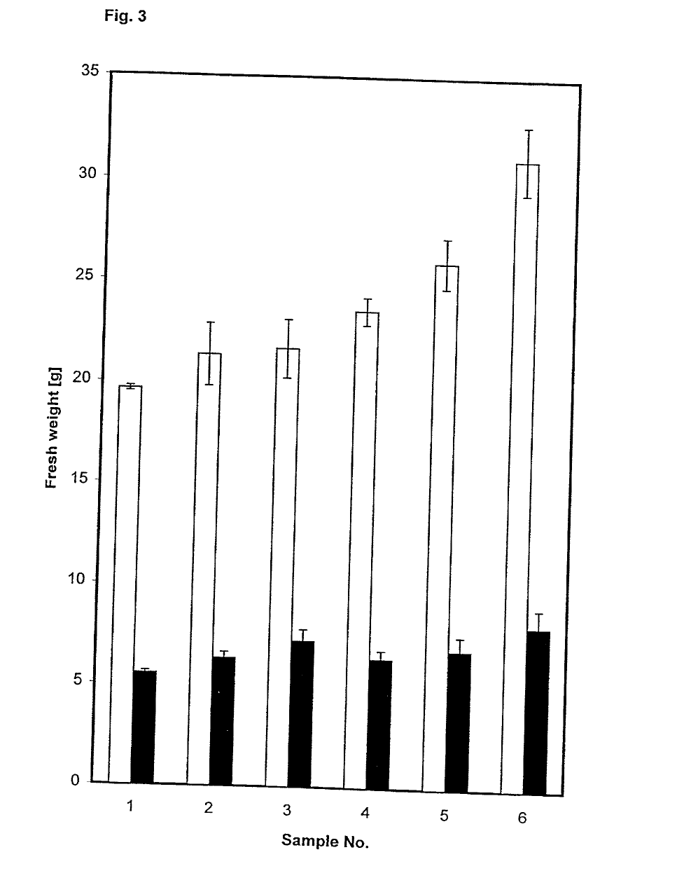

FIG. 3 shows the influence of the phosphorus desorption of the six samples of phosphorus doped activated alumina on plant fresh weight (hollows bars: leaves, solid bars: stem). Plant fresh weight was affected to a lesser extent than plant height.

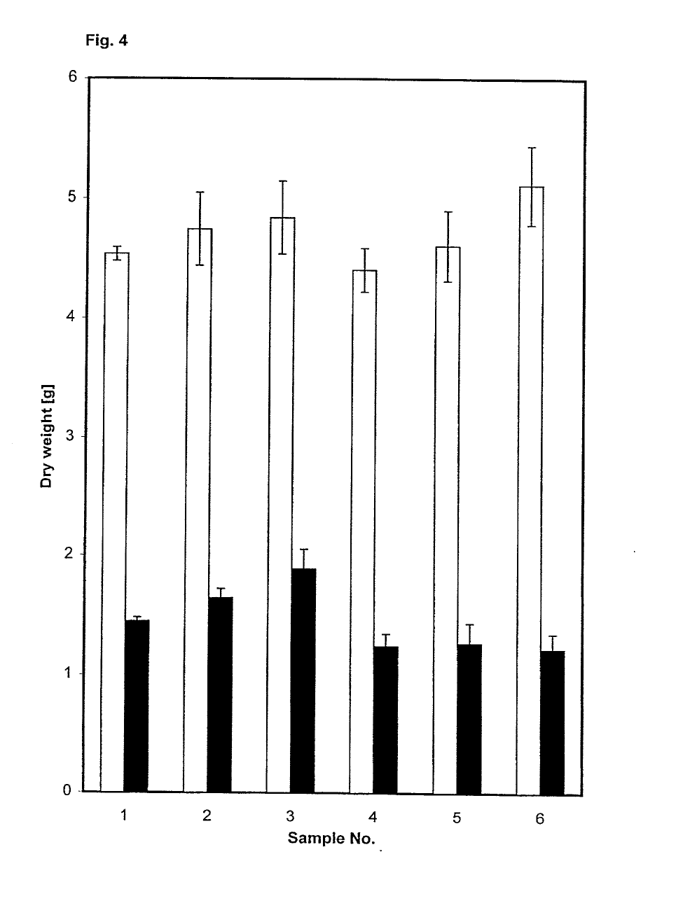

FIG. 4 shows the influence of the phosphorus desorption of the six samples of phosphorus doped activated alumina on plant dry weight (hollows bars: leaves, solid bars: stem). Also plant dry weight was affected to a lesser extent than plant height.

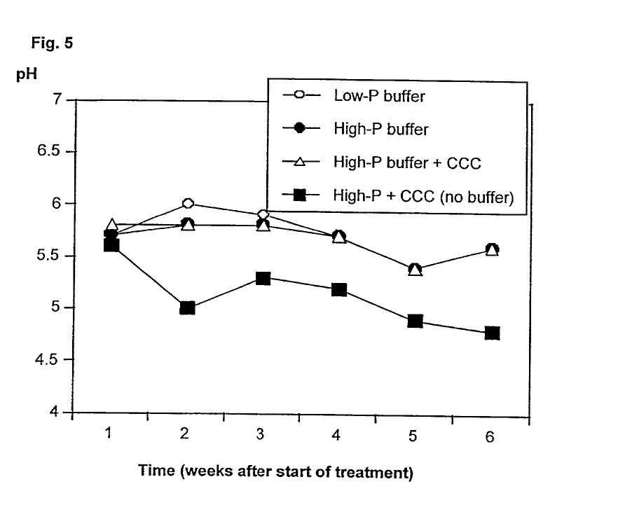

FIG. 5 shows the pH buffering behaviour of two different products according to the invention (“Low-P buffer” and “High-P buffer”) during the production of Argeranthemum frutescens on peat based growing media. In one case, a common chemical growth retardant (cycocel, “CCC”) was used in addition to High-P buffer while in one comparison example (solid square dots) only dissolved phosphate was used together with cycocel.

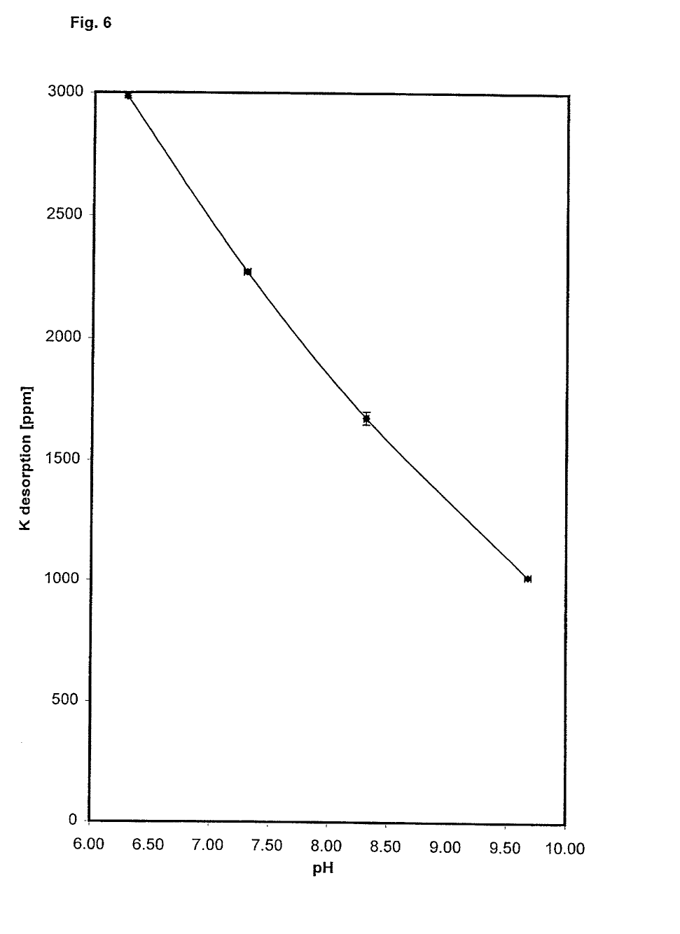

FIG. 6 shows the pH dependency of the potassium desorption from phosphorus doped activated alumina according to the invention. One part (per weight) of alumina was added to five parts of demineralised water. The diagram shows high potassium desorption in the pH range prevailing in plant culture (5.5-6).

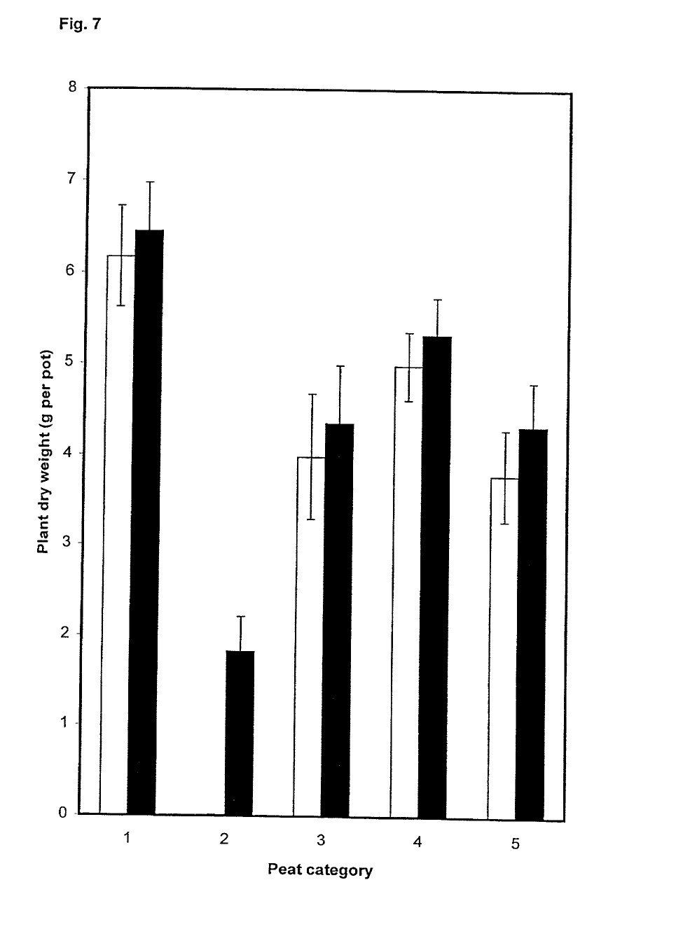

FIG. 7 shows the influence of the phosphorus doped activated alumina according to the invention on the growth rate of tomatoe (Lycopersicon esculentum Mill.) grown on different peat qualities. The solid bars refer to the results with addition of 2 vol.% phosphorus doped activated alumina while the hollow bars refer to the results obtained without addition. The peat categories were:

(1) peat without any known problems (control);

(2) lithuanian peat without fertilizer and not limed;

(3) peat where self-heating had occured;

(4) peat where problems had been identified in potted plant nurseries, samples taken prior to plant cultivation; and

(5) same as (4), samples taken after plant cultivation. Five seeds were sown per pot and the plants were irrigated with a weak nutrient solution (EC 1.6, pH 6.0). The plant dry weight was determined after 4 weeks.

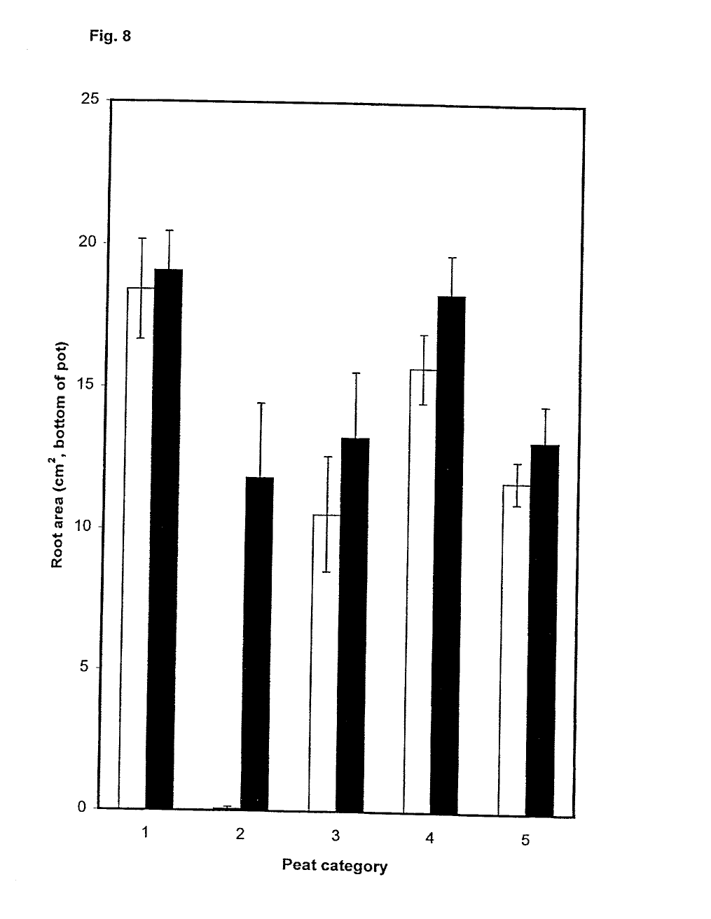

FIG. 8 shows the root area (measured on the bottom of the pot) of tomato grown under the same conditions as described above for FIG. 7.

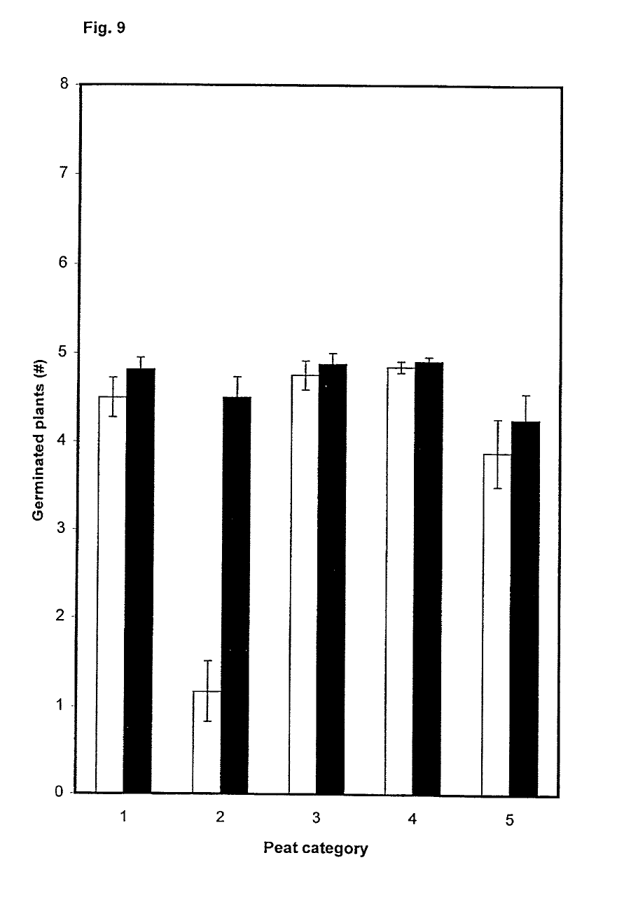

FIG. 9 shows the germination rate of tomato measured 10 days after sowing. The other conditions were the same as described above for FIG. 7.

While the claimed invention has been described in detail and with reference to specific embodiments thereof, it will be apparent to one of ordinary skill in the art that various changes and modifications can be made to the claimed invention without departing from the spirit and scope thereof.

1. A process for the production of granules of a phosphorus doped activated alumina comprising the steps of:
compacting a mixture comprising a phosphorus source and at least one of an aluminium hydroxide or an aluminum hydroxide containing material;
size reducing the compacted material to form granules;
activating the granules at a temperature of at least 300° C.; and
optionally classifying the obtained granules.

2. A process according to claim 1, wherein the granules are activated at a temperature of 350° C. to 600° C.

3. A process according to claim 1, wherein a Bayer aluminium hydroxide having a grain diameter in the 50% range (d₅₀) of 30 μm to 150 μm is used as aluminum hydroxide.

4. A process according to claim 1, wherein the source of aluminum hydroxide comprises a pseudoboehmite having the formula AIOOH.

5. A process according to claim 1, wherein the source of aluminum hydroxide containing material comprises at least one selected from the group consisting of bauxites, natural raw materials containing naturally occurring phases of aluminium hydroxide, gibbsite, boehmite, and diaspore.

6. A process according to claim 1, wherein the phosphorus source comprises at least one selected from the group consisting of phosphoric acid, salts derived from phosphoric acid, mineral phosphates or mixtures thereof.

7. A process according to claim 1, wherein the phosphorus source comprises at least one salt derived from phosphoric acid selected from the group consisting of phosphates, monohydrogenphosphates or dihydrogenphosphates of potassium, magnesium, calcium, zinc, iron or copper.

8. A process according to claim 1, wherein a mixture of phosphoric acid and salt derived from phosphoric acid is used, the ratio of phosphoric acid to salt derived from phosphoric acid being 1:0.3 to 1:20.

9. A process according to claim 1, wherein the content of the phosphorus source in the mixture to be compacted is 1 wt. % to 20 wt. %.

10. A process according to claim 1, wherein the compaction takes place in the nip between two rotating rollers, whereby the mixture is exposed to a pressure of 50 to 200 kN/cm.

11. A process according to claim 1, wherein the compacted mixture is size reduced and granulated in such a manner that at least 95 wt. % of the resulting granules E$ have a particle size between 0.1 mm and 1.50 mm.

12. A process according to claim 1, wherein the activation takes place in a rotary kiln at a temperature of 300° C. to 800° C.

13. A process according to claim 1, wherein the activation takes place in a rotary kiln at a temperature of 350° C. to 600° C.

14. A process according to claim 1, wherein the activated granules are classified to obtain an average particle size in the 50% range (d₅₀) of 0.5 mm to 1.0 mm.

15. A process according to claim 1, wherein the activated granules have a specific surface area according to BET of 120 m²/g to 380 m²/g and a loss on ignition (1200° C.) between 1% and 15%.

16. A process according to claim 1, wherein the activation step is conducted for a time sufficient to raise the temperature of the granules to a desired activation temperature.

17. A process according to claim 16, wherein the activation step is conducted for a time period of from 20 minutes to 90 minutes.

18. A process for the production of granules of a phosphorus doped activated alumina comprising the steps of:
compacting a mixture comprising a phosphorus source and an aluminium hydroxide;
size reducing the compacted material to form granules;
activating the granules at a temperature of at least 300° C.; and
optionally classifying the obtained granules.

19. A growth regulator for horticulture, comprising granules of a phosphorus doped activated alumina having a phosphorus content of 1 to 20 wt. % PO₄³⁻, a specific surface area (BET) of 120 m²/g to 380 m²/g, a moisture (300° C.) of less than 5%and a loss on ignition (1200° C.) of 1% to 15%.

20. A growth regulator for horticulture according to claim 19, wherein the granules have a loss on ignition (1200° C.) of 4% to 10%.

21. A growth regulator for horticulture according to claim 19, wherein the granules have a moisture (300° C.) of less than 1.5%.

22. A granular phosphorus doped activated alumina according to claim 19, wherein the average particle size of the granules is in the 50% range (d₅₀) is 0.5 mm to 1.0 mm.

23. A granular phosphorus doped activated alumina according to claim 19, wherein the granules are formed by the process comprising the steps of:
compacting a mixture comprising a phosphorus source and at least one of an aluminium hydroxide or an aluminum hydroxide containing material;
size reducing the compacted material to form granules;
activating the granules at a temperature of at least 300° C.; and
optionally classifying the obtained granules.

24. A method of controlling the growth of plants comprising:
adding a growth regulator comprising granules of a phosphorus doped activated alumina having a phosphorus content of 1 to 20 wt. % PO₄³⁻, a specific surface area (BET) of 120 m²/g to 380 m²/g, a moisture (300° C.) of less than 5%and a loss on ignition (1200° C.) of 1% to 15% to the growth medium.

25. A method of controlling the growth of plants according to claim 24, wherein the growth regulator provides a desorption of phosphorus resulting in a phosphorus concentration in a liquid phase in the range of 5 to 5000 μM.

26. A method of controlling the growth of plants according to claim 24, wherein the growth regulator provides a desorption of phosphorus resulting in a phosphorus concentration in a liquid phase in the range of 5 to 100 μM.

27. A method of controlling the growth of plants according to claim 24, wherein the growth regulator provides a desorption of phosphorus resulting in a phosphorus concentration in a liquid phase in the range of 10 to 50 μM.

28. A method of controlling the growth of plants according to claim 24, wherein the plants are potted plants.

29. A method of controlling the pH in a growth medium for growing plants comprising:
adding granules of a phosphorus doped activated alumina having a phosphorus content of 1 to 20 wt. % PO₄³⁻, a specific surface area (BET) of 120 m²/g to 380 m²/g , a moisture (300° C.) of less than 5%and a loss on ignition (1200° C.) of 1% to 15% to the growth medium.

30. A method of ameliorating growth of plants growing in peat containing soluble organic compounds that inhibit growth or germination, the method comprising:
adding a growth regulator comprising granules of a phosphorus doped activated alumina having a phosphorus content of 1 to 20 wt. % PO₄³⁻, a specific surface area (BET) of 120 m²/g to 380 m²/g, a moisture (300° C.) of less than 5%and a loss on ignition (1200° C.) of 1% to 15% to the peat.

31. A method of buffering a macronutrient in a growth medium comprising:
adding a growth regulator comprising granules of a phosphorus doped activated alumina having a phosphorus content of 1 to 20 wt. % PO₄³⁻, a specific surface area (BET) of 120 m²/g to 380 m²/g, a moisture (300° C.) of less than 5%and a loss on ignition (1200° C.) of 1% to 15% to the growth medium to thereby control a concentration of the macronutrient in the growth medium.

32. A method according to claim 28, wherein the macronutrient comprises at least one selected from the group consisting of Mn, Fe, Cu, Zn, and Mo.
